(19) United States
(12) Patent Application Publication
(10) Pub. No.: US 2005/0130526 A1
(43) Pub. Date: Jun. 16, 2005

(54) Support intended to be siliconized by silicones (ltc)

(76) Inventors: Gilles Gauthier, Salaise sur Sanne (FR); Carlo Cerutti, Lanzo Torinese (IT)

Correspondence Address: NIXON & VANDERHYE, PC, 1100 N GLEBE ROAD, 8TH FLOOR, ARLINGTON, VA, 22201-4714, US

(21) Appl. No.: 10/520,848

(22) PCT Filed: Jun. 27, 2003
(86) PCT No.: PCT/FI03/00523

(30) Foreign Application Priority Data
Jul. 17, 2002 (FR) 02/09019

(51) Int. Cl. B32B 27/04; B32B 27/12

(52) U.S. Cl. 442/149

(57) ABSTRACT

Use of a support based on cellulose fibers covered on at least one of its sides with a composition comprising a styrene butadiene copolymer for the siliconizing by LTC-silicone.

The invention relates to the use of a support based on cellulose fibres for siliconizing by silicones cross-linking at low temperature, denoted in the rest of the claims by the expression “LTC-silicones”.

The siliconized supports are used as supports for self-adhesive labels in reels or for supports of adhesive tapes as well as for different industrial applications (in the case of glassines). Siliconized supports on coated papers are intended to be put on the market of self-adhesive labels in bureau size or of large-sized self-adhesive labels and support for adhesive strips for markets such as female hygiene or envelope.

In practice, the siliconized supports form a structure on which the self-adhesive labels or products are maintained before their use, thus allowing not only to protect them (especially their adhesive surface), but also to enhance their dehesion by assuring a perfect adhesive transfer.

The silicones used at the moment for siliconizing are classified according to their cross-linking mode. A first category is formed by the silicones cross-linking under UV-radiation or electron beams. This category will not be described in more detail insofar as, as well for economical as for technical reasons, it is a minority group. The second category is formed by the so-called “thermal cross-linking” silicones i.e. of the silicones cross-linking at a sheet surface temperature of between 110 and 130° C. In this case, the support coated with silicone is passed through an oven, the temperature of which is such that the temperature at the surface of the paper corresponds to the cross-linking temperature of the silicone.

For reducing to a maximum the quantity of the deposited silicone, the supports able to be siliconized by the thermal silicones have to have a silicone barrier property. Generally, the supports suggested for siliconization are formed of a cellulose support covered with a layer of water-soluble binders and of latex, able to further comprise pigments. The supports can be manufactured according to different processes, by coating, size press or metering size press, followed by a calendering or supercalendering step.

These techniques lead us to obtain supports of different qualities in terms of mechanical resistance, transparency, density, silicone barrier and dimensional stability.

The supports having a good dimensional stability, but a lower mechanical resistance, transparency and density correspond to coated papers. Due to the above-mentioned characteristics, this support exhibits a more specific application in the filed of office labels or large-sized labels as well as on the hygiene market and envelope, in which the application is performed manually. These papers are composed of a support based on cellulose fibres, covered with at least one coating, even two layers of a mixture usual in paper-making based on pigments (generally kaolin, calcium carbonate), binders (starch, PVA, latex), the coated paper then being calendered. To obtain a satisfactory silicone barrier, it is necessary to coat the paper from 5 to 12 g/m² of the pigment-based mixture.

The supports having a high density, mechanical resistance and transparency but a dimensional stability less then in the coated papers are known by the name “glassine”. The glassines are particularly interesting papers for the “catch-weight” market and for the market of two-sided adhesive tapes. These papers are obtained by covering a cellulose support by means of a water-soluble binder mixture of the starch and/or polyvinyl alcohol type (PVA), generally in the presence of a viscofying agent e.g. the carboxymethylcellulose (CMC). Except for the coated papers, the cellulose support is more refined and not coated but the surface is treated with a size press or a metering size press before the ultimate step of, not calendering, but supercalendering. In practice, the weight of the layer is between 2 and 4 g/m² for the two sides. In the rest of the description, the expression “standard glassines” denotes such papers.

Another type of support corresponds to a support called “SCK”, the structure of which is very close to that of a standard glassine, the main difference being the fact that the supercalendering operation is replaced in most of the cases by a calendering operation. It follows that a less transparent support, less dense than a standard glassine, is obtained. These papers are manufactured exclusively for the American market.

The document WO 01/04418 describes a glassine type paper, the coating layer of which is different from that of a standard glassine. The coating composition is in fact formed of an aqueous emulsion made of a functionalized polyorganosiloxane (POS) grafted on to an acrylic type polymeric material. As shown in this document, the silicone barrier is clearly improved compared to the one obtained with the standard glassines.

A new family of thermal silicones developed at the moment is called “LTC” (Low Temperature Curing) corresponding to silicones, the polymer and/or cross-linking agent of which have been chemically modified so as to allow this system to cross-link at temperatures lower than those of the standard systems i.e. at temperatures lower then 100° C., in practice between 60° C. and 100° C.

The Applicant is not aware of any support for siliconizing by LTC suggested at the moment on the market and this despite that fact that the siliconizers are expected.

In fact, the use of this kind of silicone has several advantages. First of all, the low cross-linking temperature allows reducing the heating temperature of the oven and thus applying to the support a smaller thermal stress allowing conserving its mechanical characteristics and its dimensional stability. Further, this fall of temperature leads to a considerable power gain. Finally, the stresses are less important at the remoistening level of the siliconized paper during the siliconization and laminating.

Another advantage is the enhancement of the productivity by affecting the passage speed of the siliconized support in the oven. In fact, the higher the running speed of the support in the oven, the higher the heating temperature has to be so that the support would have enough time to warm up to the temperature corresponding to the cross-linking temperature of the used silicone.

However, at very high heating temperatures of the oven, the energy consumption as well as the thermal stress of the paper is very important. Consequently, the passage speed cannot be increased if conventional silicones are used as it would be necessary to rise considerably the temperature in order to heat the support to a temperature between 110 and 130° C. corresponding to the cross-linking temperature of conventional silicones. On the other hand, the use of LTC-properties of these silicone systems should allow maintaining the heating temperatures of the oven at usual values while still increasing the machine speed as high as 1000 m/min, even 1 500 m/min, while still maintaining a temperature of the support under 100° C.

On account of these perspectives, there is a special interest in developing supports that can be siliconized by the LTC-silicones with the intention of, either obtaining a power gain or enhancing the productivity, the latter point remaining nevertheless the most important.

During his research, the Applicant has noticed that the LTC-silicones were especially difficult, even impossible, to bond especially on the previously described supports, as can bee seen later, on the standard glassines, the SCK's or the supports described in the document WO 01/04418. This phenomenon is due to the modification that the LTC-silicones are subjected to for cross-linking at low temperature.

Thus, the problem that the invention proposes to solve is how to develop supports that can be siliconized by LTC i.e. supports treated so as to allow an efficient and durable anchoring of the LTC-silicones while still maintaining a perfect functionality of the siliconized paper.

Within the framework of his research, the Applicant has quite surprisingly noticed that the application of a styrene butadiene copolymer to the surface of a cellulose support allowed anchorage of the LTC-silicones while still maintaining a perfect cross-linking and control of the release performances in time.

Consequently, the invention relates to the use of a support based on cellulose fibres covered on at least one of its sides with a composition comprising a styrene butadiene copolymer for the siliconizing by LTC-silicone.

In the rest of the description and in the claims, the expression styrene butadiene copolymer denotes copolymer particles based on submicronic poly(styrene co-butadiene) dispersed in water and stabilized by the presence of surfactants.

Also, the expression “support based on cellulose fibres” denotes a support comprising cellulose fibres more or less refined depending on the desired characteristics (density, transparency, mechanical characteristics) in proportions of between 80 and 100% by weight, the balance consisting, if need be, of synthetic fibres e.g. of the polyester, polyethylene, polypropylene, polyamide, polyvinyl chloride type and/or of artificial fibres (for example viscose, cellulose acetate) and/or natural fibres (for example cotton, wool, wood pulp) and/or carbon fibres (possibly active), and/or mineral fibres (for example glass fibres, ceramic fibres), of mineral fillers such as talc, kaolin, CaCO₃ etc.

According to a first characteristic, the styrene butadiene copolymer (SBR) represents between 10 and 100%, preferably from 15 to 90%, most preferably from 17 to 85% by dry weight of the composition.

In a first embodiment, the composition covering the support is pigment-free and contains:
at least 65%, advantageously 70%, preferably 80% by dry weight of SBR,
from 5 to 30%, advantageously from 8 to 25% by dry weight of water-soluble binders,
the balance to 100% consisting of usual additives,
   the composition being applied in an amount of 1 to 2 g/m² as dry matter.

The expression “usual additives” denotes the insolubilizing agents, the viscofying agents, the antifoams and any component necessary for the good rheology of the composition.

As water-soluble binders, the composition comprises advantageously a mixture of polyvinyl alcohol/starch in a ratio of between 40/60 and 60/40, advantageously 50/50. In a preferred embodiment, the composition contains as water-soluble binders only polyvinyl alcohol.

This type of support is obtained by surface application by size press or metering size press of the composition on the support based on refined cellulose fibres, followed by a supercalendering or a simple calendering step.

When the supercalendering is carried out, the refined nature of the support, the operation of supercalendering as well as the coating weight make this support a paper corresponding to the definition of glassine i.e. a support having a high transparency and density, having high mechanical characteristics as well as an excellent silicone barrier. In the rest of the description, and especially in the examples, this support will be referred to by the term “LTC-glassine”.

On the other hand, when a simple calendering step is carried out, the obtained paper has a lower density and transparency. In practice, this kind of papers are, as already said, known by the name “SCK” and they are developed almost only for the American market for siliconizing by conventional silicones. In the rest of the description and especially in the examples, this support will be referred to by the term “LTC SCK”.

As far as the Applicant knows, supports treated with a strong proportion of SBR, which could be similar either to glassines or to SCK's according to the nature of the final calendering, have not been known before, with the exception of one LTC-application.

Consequently, a support based on cellulose fibres, at least one side of which being covered with a pigment-free composition and comprising at least 65%, preferably 70%, more preferably 80% by dry weight of SBR, from 5 to 30%, advantageously from 8 to 25% by dry weight of water-soluble binders, the balance to 100% consisting of usual additives, the composition being applied in an amount of 1 to 2 g/m² as dry matter, is thus also part of the invention as well as its manufacturing process. Especially, the support covered with the composition is first subjected to a calendering step for obtaining a “LTC SCK” or a supercalendering step for obtaining a “LTC-glassine”.

In another embodiment, the composition covering the support contains:
at least 10%, preferably between 20 and 30%, most preferably between. 21 and 25% by dry weight of SBR,
at least 50%, preferably between 60 and 75%, most preferably 70% by dry weight of pigments,
between 5 and 10%, advantageously 7% by dry weight of water-soluble binder,
the balance to 100% consisting of usual additives,
   the composition being applied in an amount of between 4 and 6 g/m² as dry matter.

The pigments can be of different nature such as kaolin, aluminium hydroxide and talc etc, even if in practice, the calcium carbonate is preferred. Also, as water-soluble binders are advantageously used the starch, PVA etc.

This type of a support is manufactured by coating by means of a coater or by surface application by a size press or metering size press of the composition on the support based on refined cellulose fibres, followed by a supercalendering step, also here in order to obtain a paper having characteristics such as those close of a glassine. In a special embodiment, before the coating of the composition comes a preceding treatment step intended for clogging the pores of the paper. This treatment takes place in practice by size-press or metering size press by impregnation of a layer, based on water-soluble binders and insolubilizing agents, applied in an amount of 0.5 to 1.5 g/m² as dry matter. In the rest of the description and especially in the examples, this support will be called “LTC-pigmented glassine”.

In a third embodiment, the composition covering the support contains:
at least 10%, advantageously between 16 and 25% by dry weight of SBR,
at least 60%, advantageously between 70 and 80% by dry weight of pigments,
between 0.5 and 10%, advantageously between 1 an 8% by dry weight of water-soluble binders,
the balance to 100% consisting of usual additives,
   the composition being coated in an amount of 5 to 12 g/m² as dry matter.

This type of support is obtained by coating of the composition on the support, as one or two layers, by means of a coater, the support based on cellulose fibres not being especially refined compared with the fibres used in the glassines or SCK's, and followed by a calendering step. In a special embodiment, the coated coating of the layer is preceded by a pore filling treatment in the same conditions as those previously exposed. Due to the mass of the layer and the quality of the used cellulose fibres, these coated supports are not particularly transparent and are thus especially adapted to the office-size self-adhesive label or large-size self-adhesive label market and supports for self-adhesive tapes for the markets such as female hygiene or envelope due to their very good dimensional stability. In the rest of the description, and especially in the examples, this support will be called “LTC-coated paper”.

The invention and the advantages which stem therefrom will become more apparent from the following illustrative examples supported by the appended figures.

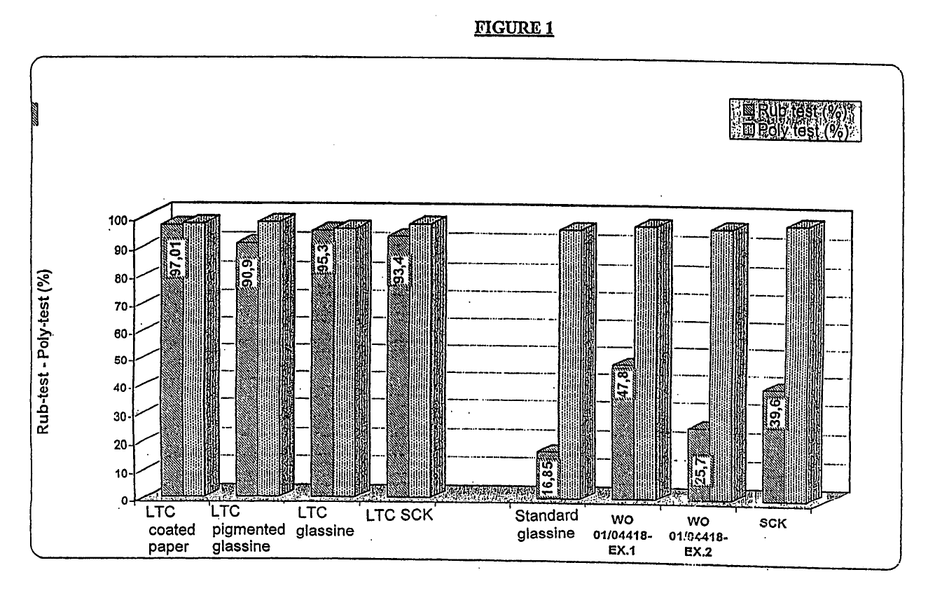

The FIG. 1 represents the results of the Poly-test and Rub-test for all of the tested supports, these two tests being used to measure the anchorage and cross-linking level of the silicone film on the support.

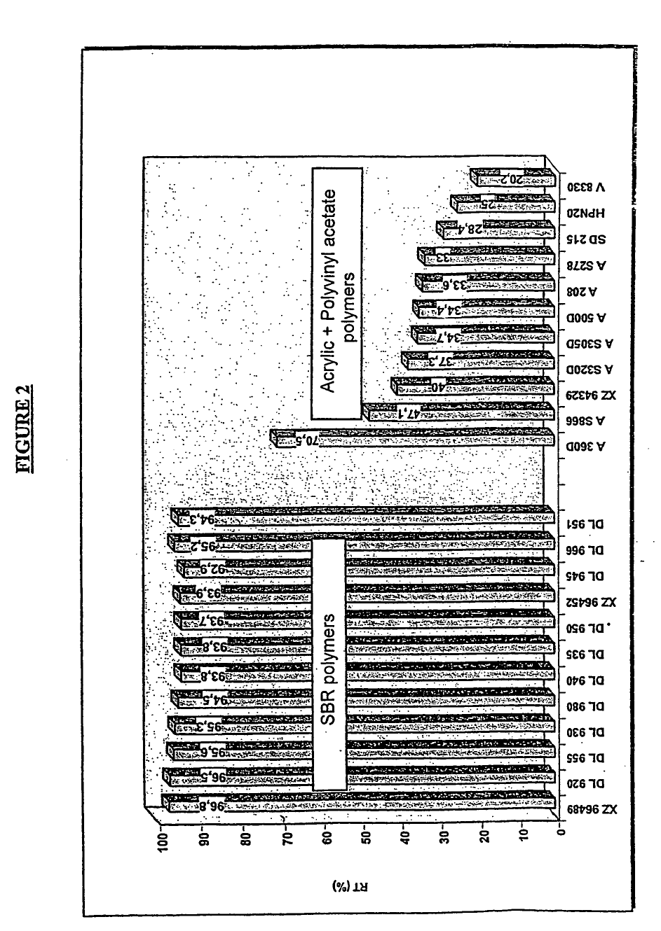

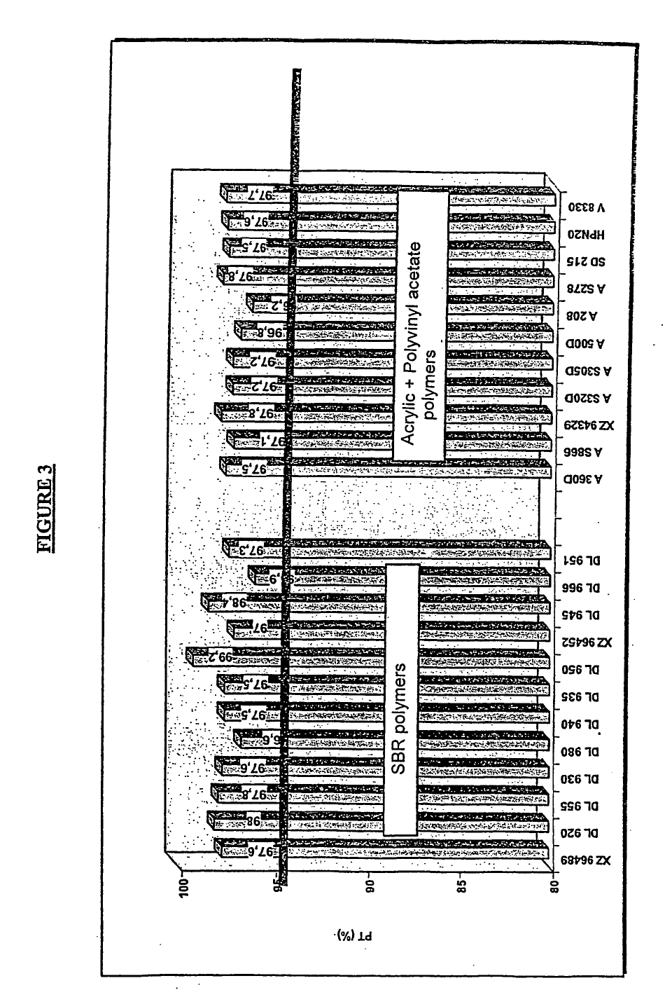

The FIGS. 2 and 3 represent the results of the Rub-test and Poly-test for different polymers tested in the composition covering the support.

### 1/Manufacturing of the Supports of the Invention

Four supports able to be siliconized by LTC according to the invention are prepared. The four supports are obtained after a surface application or coating step of the composition of the invention on a cellulose support, followed by a calendering or supercalendering operation. The surface application operations are carried out by size press, whereas the coating operation is carried out by a blade coater. These techniques are perfectly known by the expert so that they do no need to be described later in more detail, and so is the case with calendering and supercalendering operations. The characteristics of these four supports, in terms of composition as well as in terms of process, are given in the following table.

| | | | | LTC-pigmented | LTC-coated |
|---|---|---|---|---|---|
| | | LTC-glassine | LTC SCK | glassine | paper |
| Composition | Pigments | | | 68² | 71.8 |
| of the | | | | =>CaCO3 | =>36.6 kaolin¹⁰ |
| surface | | | | | =>35.2 CaCo3¹¹ |
| layer | SBR latex¹ | 68.8¹ | 82.6¹ | 23.8¹ | 19.9¹ |
| in % by dry | Starch | 11.5³ | | 6.8⁴ | 7.0⁴ |
| weight | PVOH | 11.5⁷ | 9.2⁷ | | |
| | Carboxymethylcellulose | 6.4⁸ | 6.4⁸ | 0.61⁹ | 0.6⁹ |
| | Insolubilizing agent | 1.8⁵ | 1.8⁵ | 0.61⁵ | 0.3⁵ |
| | Sizing product | | | 0.14⁸ | 0.4⁶ |

| | | | | |
|---|---|---|---|---|
| Support based on cellulose | Support 100% | Support 100% | Support 100% | Support 100% |
| fibres + grammage | cellulose 60 g/m² | cellulose | cellulose 57 g/m² | cellulose 52 g/m² |
| | | 60 g/m² | | |
| Process | Size press + | Size press + | Size press + | Double coating + |
| | supercalendering | calendering | supercalendering | caleandering |
| Coating weight of the layer (per side) | 2 | 2 | 5 | 10 |

¹DL 950 ® (DOW CHEMICAL)
²CARBITAL 95 ® (IMERYS)
³KOFILM 80 ® (National Starch)
⁴AMYLEX ® 20/20 (SÜDSTÄRKE)
⁵BACOTE ® (MEL CHEMICAL)
⁶BAYSINTHOL KSNB ® (BAYER)
⁷POVAL 117 H ® (KURARAY)
⁸FINNFIX 4000 G ® (NOVIANT)
⁹CMC T50 ® (LAMBERTI)
¹⁰ASTRAFINE LX ® (IMERYS)
¹¹CARBITAL 90 ® (IMERYS)

### 2/Manufacturing of the Prior Art Supports

In this example three supports, known in the prior art for their capacity of being siliconized by conventional silicone, were produced (cross-linking temperature between 110 and 130° C.), respectively, a standard glassine, a SCK, a support according to the document WO 01/04418.

In the same way as in the example 1, the characteristics of these three supports are given in the following table.

| | | Standard | | WO 01/04418 | |
|---|---|---|---|---|---|
| | | glassine | SCK | Ex. 1 | Ex. 2 |
| Composition | Starch | | 77-92⁹ | | |
| of the surface | PVOH | 70-80⁸ | 4-19¹⁰ | | |
| layer | Carboxymethylcellulose | 15-25⁷ | | | |
| (in % by dry | POS | | | 81¹ | 81.8¹ |
| weight) | Methacrylate | | | 16.6² | 16.7² |
| | copolymer | | | | |
| | Insolubilizing agent | 5⁸ | 4⁸ | 2.4³ | |
| | Calendering wax | | | | 1.4⁴ |
| | Antifoam | | | | 0.1⁵ |

| Support | Support 100% | Support 100% | Support 100% cellulose 60 g/m² | |
|---|---|---|---|---|
| based | cellulose 60 g/m² | cellulose | | |
| on cellulose | | 60 g/m² | | |
| fibres + grammage | | | | |
| Coating | 1-2 g/m² | 1-2 g/m² | 2-3 g/m² | |
| weight | | | | |
| of the layer | | | | |
| per side | | | | |
| Process | Size press + | Size press + | Size press + | Size press + |
| | supercalendering | calendering | supercalendering | supercalendering |

¹SILICOLEASE 700 ® (RHONE POULENC)
²PRIMAL HG44 ® (RHOM & HAAS)
³BACOTE 20 ® (MEL CHEMICAL)
⁴WAX CARTASEAL FGU (MEL CHEMICAL)
⁵TPE 714 ® (HENKEL)
⁶ERKOL 28/99 ® (ERKOL)
⁷CARBOCELL T 650 ® (LAMBERTI)
⁸CARTABOND TSI ® (CLARIANT)
⁹PENFORD GUM 290 ® (PENFORD CORPORATION)
¹⁰AIRVOL 325 ® (AIR PRODUCTS)

### 3/Siliconizing of the Supports of the Examples 1 and 2 by LTC

The capability of the supports manufactured according to the examples 1 and 2 intended to be siliconized by LTC is determined in relation to the cross-linking rate (Poly-test) and to the anchorage rate (Rub-test).

A Rub-test superior to 85% means that the bonding of the silicone is good.

A Rub-test superior to 95% testifies to a satisfactory cross-linking.

The silicone used for LTC-siliconizing contains a cross-linking agent sold by WACKER under the name XL V525; the complete system used being as follows:

| | |
|---|---|
| Resin D.920 | 20 g |
| XL V525 | 1,432 g |
| Cat. O.L | 0,214 g |

The cross-linking conditions are of 80° C. during 30 seconds.

The results are given in the following table and are represented in the FIG. 1.

| Paper | Rub-test (%) | Poly-test (%) |
|---|---|---|
| LTC-coated paper | 97.01 | 97.6 |
| LTC-pigmented glassine | 90.9 | 98.1 |
| LTC-glassine | 95.3 | 96.0 |
| LTC SCK | 93.4 | 97.6 |
| Standard glassine | 16.85 | 96 |
| WO 01/04418-EX. 1 | 47.8 | 97.5 |
| WO 01/04418-EX. 2 | 25.7 | 96.8 |
| SCK | 39.6 | 98.2 |

As can be seen from the results, the supports of the invention, the coating of which contains SBR, have the bonding properties of LTC-silicone far better then those of the prior art supports.

### 4/Polymer in the Composition Covering the Support

This example aims to show that only the copolymers based on styrene butadiene allowing obtaining a good anchorage of the LTC-silicones, unlike other polymers, especially the polymers belonging to the family of acrylic polymers and polyvinyl acetate.

The practice is as follows: a paper support sold under the name “silca white” by the Applicant is coated with a composition comprising 100% by weight of polymers identified in the table below. The layer is applied by coating in an amount of 1 g/m². Then the coated paper is calendered.

On each sample is then applied an LTC-silicone, the composition of which is as follows:

| | |
|---|---|
| Resin D920 | 20 g |
| Crosslinker V525 | 1,432 g |
| Cat. O.L. | 0,214 g |

The cross-linking conditions are 80° C. during 30 seconds.

The different tested polymers and their characteristics are represented in the following table.

| Ref. | Suppliers | Nature | Rub-test | Poly-test |
|---|---|---|---|---|
| XZ 96489 | Dow Chemical Company | SBR | 96.8 | 97.6 |
| DL 920 | Dow Chemical Company | SBR + ACRYLONITRILE | 96.5 | 98 |
| DL 955 | Dow Chemical Company | SBR + ACRYLONITRILE | 95.6 | 97.8 |
| DL 930 | Dow Chemical Company | SBR | 95.3 | 97.6 |
| DL 980 | Dow Chemical Company | SBR + ACRYLONITRILE | 94.5 | 96.6 |
| DL 940 | Dow Chemical Company | SBR + ACRYLONITRILE | 93.8 | 97.5 |
| DL 935 | Dow Chemical Company | SBR + ACRYLONITRILE | 93.8 | 97.5 |
| DL 950 | Dow Chemical Company | SBR | 93.7 | 99.2 |
| XZ 96452 | Dow Chemical Company | SBR + ACRYLONITRILE | 93.9 | 97 |
| DL 945 | Dow Chemical Company | SBR | 92.9 | 98.4 |
| DL 966 | Dow Chemical Company | SBR + ACRYLONITRILE | 95.2 | 95.9 |
| DL 951 | Dow Chemical Company | SBR | 94.3 | 97.3 |
| A 360D | B.A.S.F. | STYRENE ACRYLATE + ACRYLONITRILE | 70.5 | 97.5 |
| A S886 | B.A.S.F. | STYRENE ACRYLATE + ACRYLONITRILE | 47.1 | 97.1 |
| XZ 94329 | Dow Chemical Company | STYRENE ACRYLATE | 40 | 97.8 |
| A S320D | B.A.S.F. | STYRENE ACRYLATE | 37.3 | 97.2 |
| A S305D | B.A.S.F. | STYRENE ACRYLATE | 34.7 | 97.2 |
| A 500D | B.A.S.F. | ACRYLATE/VINYL ACETATE | 34.4 | 96.8 |
| A 208 | Latexia | POLYVINYL ACETATE | 33.6 | 96.2 |
| A S278 | B.A.S.F. | STYRENE ACRYLATE | 33 | 97.8 |
| SD 215 | Latexia | STYRENE ACRYLATE | 28.4 | 97.5 |
| HPN20 | Dow Chemical Company | STYRENE ACRYLATE | 25 | 97.6 |
| V 8330 | Vinamul | POLYVINYL ACETATE | 20.2 | 97.7 |

A representation of the Rub-test and Poly-test results can be seen in FIGS. 2 and 3.

As can be seen from these figures, the results of the Poly-test are quite similar as far as all the tested polymers are concerned, showing a perfect cross-linking of silicone in LTC-conditions (value superior to 95% for the Poly-test). On the other hand, the results of the Rub-test show that silicone anchorage is perfect on all samples coated with a styrene butadiene copolymer. On the samples based on acrylic polymers or polyvinyl acetate, the anchorage of the silicone is poor (Rub-test inferior to 85%).

1. Use of a support based on cellulose fibres covered on at least one of its sides with a composition comprising a styrene butadiene copolymer for the siliconizing by LTC-silicone, where styrene butadiene copolymer (SBR) is understood as copolymer particles based on submicronic poly(styrene cobutadiene) dispersed in water and stabilized by the presence of surfactants.

2. Use according to claim 1, characterized in that the styrene butadiene copolymer represents between 10 and 100%, preferably from 15 to 90%, advantageously from 17 to 85% by dry weight of the composition.

3. Use according to claim 1, characterized in that the composition covering the support is pigment-free and contains;
at least 65%, advantageously 70%, preferably 80% by dry weight of SBR,
from 5 to 30%, advantageously from 8 to 25% by dry weight of water-soluble binders.
the balance to 100% consisting of usual additives.
the composition being applied in an amount of 1 to 2 g/m² as dry matter.

4. Use according to claim 3, characterized in that, as water-soluble binders, the composition contains a mixture of polyvinyl alcohol/starch, in a ratio of between 40/60 and 60/40 advantageously 50/50.

5. Use according to claim 3, characterized in that the support covered with the composition has been subjected to a supercalendering step.

6. Use according to claim 3, characterized in that the support covered with the composition has been subjected to a calendering step.

7. Use according to claim 1, characterized in that the composition covering the support contains:
at least 10%, preferably between 20 and 30%, most preferably between 21 and 25% by dry weight of SBR,
at least 50%, preferably between 60 and 75%, most preferably 70% by dry weight of pigments,
between 5 and 10%, advantageously 7% by weight of water-soluble binder,
the balance to 100% consisting of usual additives,
the composition being applied In an amount of between 4 and 6 g/m² as dry matter.

8. Use according to claim 7, characterized in that the support covered with the composition has been subjected to a supercalendering step.

9. Use according to claim 1, characterized in that the composition covering the support contains:
at least 10%, advantageously between 18 and 25% by dry weight of SBR.
at least 60%, advantageously between 70 and 80% by dry weight of pigments,
between 0.5 and 10%, advantageously between 1 and 8% by dry weight of water-soluble binders.
the balance to 100% consisting of usual additives,
the composition being coated in an amount of 5 to 12 g/rn² as dry matter.

10. Use according to claim 9, characterized in that the support covered with the composition has been subjected to a calendering step.

11. Use according to claim 7, characterized in that a layer based on water-soluble binders and insolubilizing agents, applied in an amount of 0.5 to 1.5 g/m² as dry matter, is inserted between the support and the said composition.

12. A support based on cellulose fibres, at least one side of which being covered with a pigment-free composition and comprising at least 65% preferably 70%, most preferably 80% by dry weight of SBR, of 5 to 30% by dry weight of water-soluble binders, the balance to 100% consisting of usual additives, the composition being applied in an amount of 1 to 2 g/m² as dry matter.

13. The support according to claim 12, characterized in that it is subjected to a calendering or supercalendering step.
